(19) United States
(12) Patent Application Publication
(10) Pub. No.: US 2021/0231233 A1
(43) Pub. Date: Jul. 29, 2021

(54) Pipe-On-Pipe Pipe Support Apparatus and Method of Use

(71) Applicant: Martin Schutte, Lake Charles, LA (US)

(72) Inventor: Martin Schutte, Lake Charles, LA (US)

(21) Appl. No.: 17/031,139

(22) Filed: Sep. 24, 2020

Related U.S. Application Data
(60) Provisional application No. 62/965,027, filed on Jan. 23, 2020.

(51) Int. Cl. F16L 3/08; F16L 3/10

(52) U.S. Cl. CPC F16L 3/085; F16L 3/1091

(57) ABSTRACT

A pipe-on-pipe pipe support apparatus and method of use is disclosed. The pipe support apparatus has an upper corrugated support surface comprised of a series of valleys and ridges and a bottom have a support surface that conforms to the curved or circular surface of an underlying pipe support structure such as a pipe. The bottom surface and support surface create flanges or guides to hold the pipe support apparatus upon the underlying pipe support structure. The support surface may be a skid-resistant support surface. The supported piping is positioned to rest solely upon the ridges on the upper surface of the pipe support apparatus.

### PRIORITY

This application claims priority to U.S. Provisional Application Ser. No. 62/965,027 filed Jan. 23, 2020 for “Pipe Support Apparatus and Method”, the entire content of which is incorporated by reference.

### FIELD OF THE INVENTION

This invention relates generally to the field of industrial piping and piping systems and more particularly relates to a pipe-on-pipe pipe support apparatus and method of use for providing corrosion resistant pipe support surfaces on a variety of pipe support structures.

### BACKGROUND OF THE INVENTION

Piping systems are comprised of variety of components including piping segments, valves, tanks, pumps, and associated fittings and connections. Such piping systems are utilized to convey fluids including gases in a variety of industrial, chemical, commercial, and public works facilities, plants, and factories. Such fluids may be liquids, gases, and sludge including process chemicals, water, steam and combinations thereof and such fluids may be conveyed at a variety of temperatures, pressures, and velocities. Pipe supports and pipe support structures are integral components of piping systems. They are used to ensure that the span of piping segments and the fittings and connections used to connect piping segments and the valves, tanks, and other equipment incorporated into piping systems are not overstressed or overloaded. Piping systems may employ a variety of pipe supports and pipe support structures including hangers, struts, pickups, springs, beams, columns, and, in many cases, the piping of the same piping system or of an unrelated piping system.

The design and overall integrity of a piping system, its components, and its associated pipe support structures are dependent upon the type and physical properties of the fluids being conveyed by the piping system. Physical properties such as the type of fluid, the fluid weight, the fluid temperature, and the fluid pressure must be considered when designing and constructing a piping system and its associated pipe, valves, fittings, connections, equipment and pipe support structures. The physical properties of the conveyed fluids bear upon the selection of the type, weight, and dimensions of piping segments utilized in a piping system as well as the load, deflection, expansion, contraction, and deformation imposed on the piping, valves, fittings, connections, and pipe support structures incorporated into the piping system. Excessive deflection, contraction or expansion of the associated piping of a piping system will impact the loads, forces and moments transferred to critical components of the piping system which may in turn result in piping system failure. The consequences of such piping system failure may be dangerous and sometimes catastrophic and include hazardous chemicals spills, fires, and explosions.

By way of example, piping system failure may be caused by corrosion of its associated piping or of its associated pipe supports. Such corrosion may be sufficient to produce a negative effect on the load bearing characteristics of the piping system piping and its support components.

Corrosive conditions occur when piping systems are placed in an open-air environment such as in a marine or offshore installation or in a chemical plant or refinery where there is exposure to rain, wind, salt water, or corrosive chemicals.

Piping system failure may also be caused by excessive structural deflection and displacement of the piping system piping when the beams or columns utilized as part of a piping support structure are not sized to sufficiently prevent piping deflections. Such deflections and displacements may result in undesired transfer of loads and moments to the associated components and equipment of a piping system. This is often the case when an associated relief valve inlet and discharge line are not adequately supported or when an associated pipe support slips or shifts on its underlying support structure.

Piping system failure may also occur when the wall thickness of the piping used in the piping system is degraded over time. Piping wall thickness degradation may occur when the piping expands and contracts over a wear plate on a pipe support. Such expansion and contraction may weaken the walls of the piping incorporated into a piping system eventually resulting in the failure of a piping system.

Piping system failure may also be caused by vibration and oscillation of the piping of a piping system caused by rotating machinery, fluid flow, and environmental conditions such as winds, earthquakes and seismic events. Such vibration or oscillation may create stress fractures in the piping and associated valves, fittings, connections, equipment and pipe support structures of a piping system that result in piping system failure.

Piping system failure may also be caused when a pipe support does not adequately provide cathodic isolation from corrosive soils or lightning conditions. In such situations, a piping system must be isolated from support steelwork to prevent current penetration through the pipe wall rather than through a specified grounding path.

Failure of a piping system may also be caused when elements of a pipe support have been incorrectly specified and installed such that the pipe supports degrade due to environmental and piping system operating conditions such as slug flow, temperature variations, and subsidence. Incorrect design and selection of pipe supports components may also result in overloaded support beams and columns, undersized or insufficient pipe guides, slide plate failure, spring and shock absorber failure. Such conditions may also lead to piping system failure, such as piping being torn from its supports, and the resulting catastrophic consequences.

Due to such risk of failure, the piping system and its associated pipe, valves, fittings, connections, equipment and pipe support structures must be inspected regularly to assess the integrity of the piping system to predict and prevent the occurrence of piping system failure. Millions of dollars are spent each year to inspect, repair, and replace damaged piping and pipe supports of such piping systems.

Such problems are often exacerbated in cases where the pipe support is the piping of the same piping system or of an unrelated piping system because there is typically insufficient isolation of the supported piping from the support piping.

From the above, it is apparent that improvements to the pipe supports of piping systems will assist in more effectively preventing piping system failure caused or induced by inadequate pipe supports.

It is also apparent that there is a need for a pipe-on-pipe pipe support that may be readily utilized in a piping system to reduce the risk of corrosion and serve to reduce the incidence of piping system failure.

It is also apparent that there is a need for a pipe-on-pipe pipe support that may be readily utilized as a replacement or as an addition to existing pipe supports in a piping system.

It is also apparent that there is a need for a pipe-on-pipe pipe support that will result in a reduction in the cost of installation and maintenance of pipe systems.

It is also apparent that there is a need for a pipe-on-pipe pipe support that will withstand extreme temperature changes including cryogenic temperatures.

It is also apparent that there is a need for a pipe-on-pipe pipe support that will withstand extreme pressures and any extraneous conditions such as slug flow.

It is also apparent that there is a need for a pipe-on-pipe pipe support that will be resistant to slippage or shifting on its underlying support structure.

It is also apparent that there is a need for a pipe-on-pipe pipe support that will sufficiently withstand the forces, loads, and moments incurred in the piping system.

It is also apparent that there is a need for a pipe-on-pipe pipe support that may be used in a variety of environments and climate conditions including hurricane winds, earthquakes and other seismic activity, and corrosive atmospheres.

It is also apparent that there is a need for a pipe-on-pipe pipe support that will provide drainage and evaporation of rainwater and other liquids away from the piping-pipe support contact points without damaging corrosion coatings applied to the surfaces of supported piping.

It is also apparent that there is a need for a pipe-on-pipe pipe support that will provide cathodic protection for the piping system.

It is also apparent that there is a need for a pipe-on-pipe pipe support that will be fire resistant.

It is also apparent that there is a need for a pipe-on-pipe pipe support that may be manufactured from a large variety of materials.

### SUMMARY OF THE INVENTION

The present invention provides a pipe support apparatus and method for a piping system that is designed to satisfy the aforementioned needs. The present invention is a load bearing pipe-on-pipe pipe support apparatus having a support base configured to be readily mounted upon piping that is utilized as an underlying pipe support structure. Preferably the pipe-on-pipe pipe support apparatus is comprised of an isolating composite material designed to isolate the supported piping from the support piping in order to reduce corrosion due to cathodic attack produced by static electricity. Preferably the pipe-on-pipe pipe support apparatus of the present invention will be integrally cast, extruded, or protruded to meet desired thermal and mechanical requirements. Such isolating composite material will preferably be comprised of a blend of fabric reinforced thermoplastic resin material or combinations of such materials, though other types of isolating composite material such as fiber reinforced concrete may be utilized.

Depending upon the load to be supported, environmental conditions, or other design considerations, the pipe-on-pipe pipe support apparatus may also be cast, pultruded, extruded, machined, or otherwise constructed of metal or metal alloys. Preferably such a metal pipe-on-pipe pipe support apparatus will be comprised of corrosion-resistant metal or corrosion-resistant metal alloys. Such metals and metal alloys include aluminums and aluminum alloys, copper, copper-nickel alloys, brass, bronze, steel and stainless-steel alloys. When made of metal or metal alloys, the pipe-on-pipe pipe support apparatus may also be provided with a corrosion-resistant coating such as a galvanized coating, a paint, or a polymer coating.

The pipe-on-pipe pipe support apparatus preferably has a flat polygon-shaped support base with a corrugated upper surface having a series of valleys and ridges and a lower surface forming a support area configured for placement upon a curved underlying pipe support structure preferably a rounded or circular surface such as pipe beam, a pipe brace, or the piping of a piping system. The support area of the pipe-on-pipe pipe support apparatus conforms to the curved surface of the piping of the underlying pipe support structure and may be comprised of intersecting angled support areas, intersecting flat and angled support areas, or a curved support area. The support area of the pipe-on-pipe pipe support apparatus create flange or guide surfaces adjacent to the lower surface of the pipe-on-pipe pipe support apparatus that serve to hold the pipe-on-pipe pipe support in place upon the corresponding underlying pipe support structure. The pipe-on-pipe pipe support apparatus may be of any desired thickness and it will be sized in accordance with a desired pre-determined load bearing capacity.

The support area on the lower surface of the pipe-on-pipe pipe support apparatus may have a skid-resistant surface that serves to reduce the incidence of pipe support slippage or sliding on the underlying pipe support structure when in use. The skid-resistant surface may be molded or formed integrally with the support area of the pipe-on-pipe pipe support apparatus or it may be a skid-resistant coating such as a ceramic, paint, epoxy, or polymer coating having an anti-slip additive such as sand, silica, granulated stone, ceramics, or another suitable skid-resistant additive.

The pipe-on-pipe pipe support apparatus of applicant's invention may be installed upon its underlying pipe support structure during the initial construction of a piping system or it be installed upon an underlying pipe support structure of an existing piping system as an upgrade or replacement for existing pipe supports. The upgrade or replacement of existing pipe supports with the pipe-on-pipe pipe support apparatus of applicant's invention may typically be accomplished by first lifting a piping segment of the existing piping system from its existing support, then removing the existing support from its underlying pipe support structure, and then placing the pipe support apparatus of the present invention on the existing underlying pipe support structure. Typically, no welding or other attachment will be necessary.

### DESCRIPTION OF THE DRAWINGS

FIG. 1 is a top isometric view of the pipe-on-pipe pipe support apparatus in accordance with the invention set forth herein.

FIG. 2 is a top isometric view of an alternate embodiment of the pipe-on-pipe pipe support apparatus in accordance with the invention set forth herein.

FIG. 3 is a bottom isometric view of the embodiment of the pipe-on-pipe pipe support apparatus shown in FIG. 2.

FIG. 4 is an isometric top view of the pipe-on-pipe pipe support apparatus shown in FIG. 1 positioned upon the top of piping used as a piping support structure.

FIG. 5 is an end view of the pipe-on-pipe pipe support apparatus shown in FIG. 1 positioned upon the top of piping used as a piping support structure.

FIG. 6 is an end view of the pipe-on-pipe pipe support apparatus shown in FIG. 2 positioned upon the top of piping used as a piping support structure.

FIG. 7 is an end view of an alternate embodiment of the pipe-on-pipe pipe support apparatus in accordance with the invention set forth herein suspended by means of U-Bolts from the piping of a piping system utilized as the piping support structure.

FIG. 8 is an end view of an alternate embodiment of the pipe-on-pipe pipe support apparatus in accordance with the invention set forth herein attached by means of U-Bolts to the piping of a piping system used as the underlying pipe support structure with the pipe-on-pipe pipe support apparatus used to support additional piping on its upper surface.

FIG. 9 is an isometric view of the pipe-on-pipe pipe support apparatus of FIG. 2 positioned upon the top of a post or column.

FIG. 10 is a top isometric view of another alternate embodiment of the pipe-on-pipe pipe support apparatus in accordance with the invention set forth herein.

FIG. 11 is an end view of the pipe-on-pipe pipe support apparatus shown in FIG. 10 positioned upon the top of piping used as a piping support structure.

### DESCRIPTION OF THE EMBODIMENT

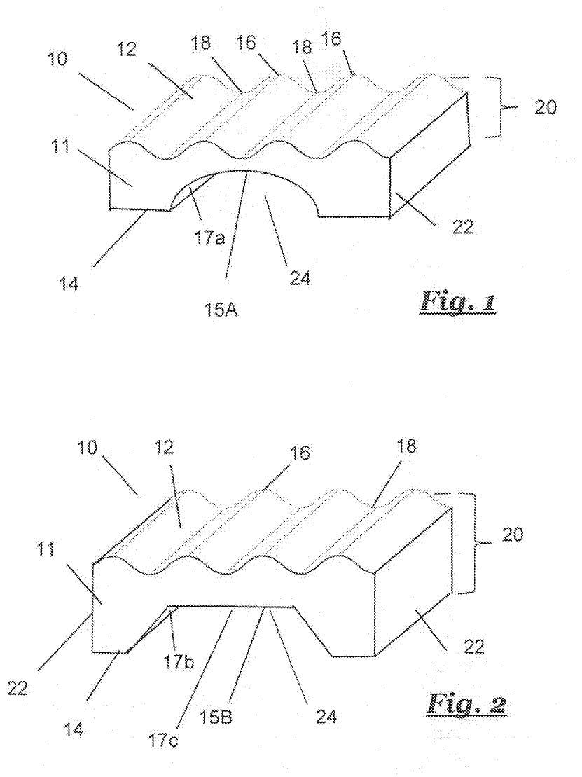

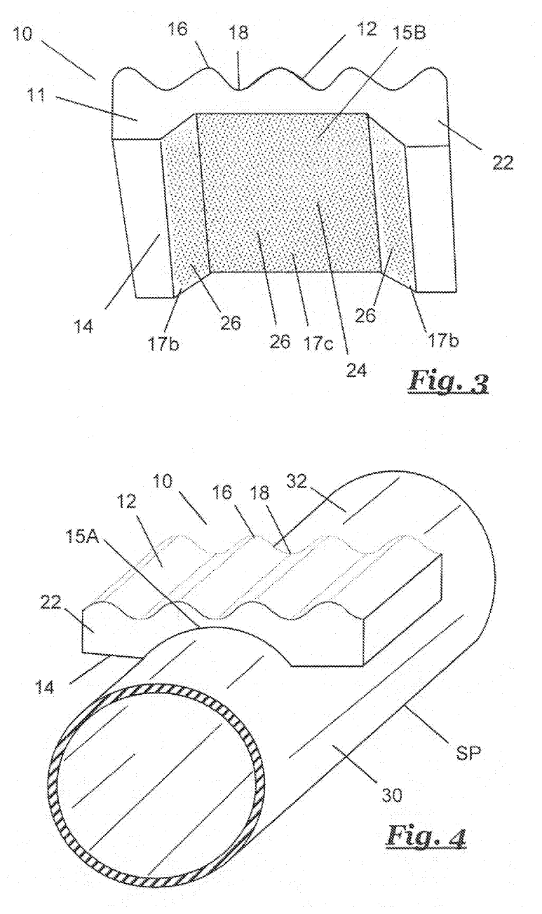

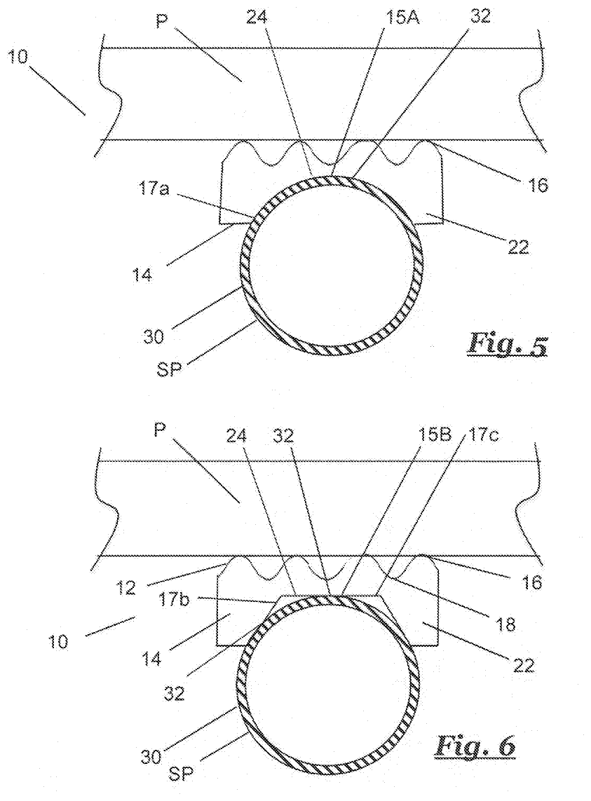

Referring to the drawings, FIGS. 1 and 2 show alternate embodiments of the pipe-on-pipe pipe support apparatus 10 of Applicant's invention. The apparatus 10 shown in FIG. 1 has a support base 11 having a corrugated upper surface or support top 12 with a series of ridges 16 and valleys 18 and a support bottom 14. Preferably, support base 11 is configured in a polygonal-shaped, such as a rectangle or square, although support base 11 may also be circular or oval in shape. Support base 11 of apparatus 10 has a height or thickness 20 sized to provide a desired pre-determined load bearing capacity for the apparatus 10. The support bottom 14 of base 11 of apparatus 10 has a pipe support area 24. Pipe support area 24 may be a curved support surface 15A with curved edges 17, as shown in FIG. 1, configured to conform to a curved underlying support surface such as a circular pipe support surface 32 as shown in FIG. 5.

Pipe support area 24 may also have a flat support surface 15B interposed between opposing support edges 17a positioned at intersecting angles as shown in FIG. 2. The opposing support edges 17a provide support surface 15B of support area 24 with beveled edge surfaces configured to conform to and intersect with a curved surface such as the circular pipe support surface 32 of underlying support structure 30 as shown in FIG. 6. Flanges or guides 22 adjacent the support edges 17 provide strength to the apparatus 10 and serve in placement and seating of the pipe support apparatus 10 upon its underlying support structure.

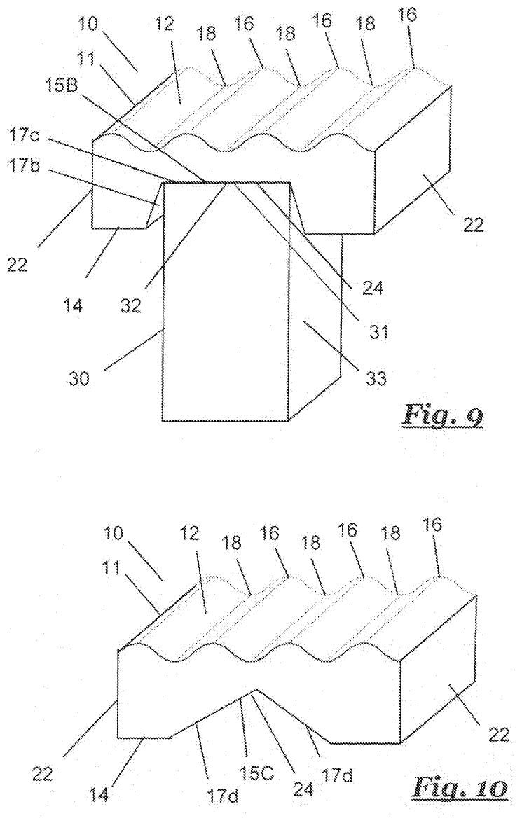

The flat support surface 15B with the opposing angled support edges 17a of support area 24 also provides an added advantage of allowing the pipe-on-pipe pipe support apparatus 10 shown in FIG. 2 to be used upon both an underlying support structure 30 having a curved upper surface 32 as shown in FIG. 6 or upon an underlying support structure 30 having a flat upper surface 33 such as the flat top of a beam flange or the flat top 31 of a column as shown in FIG. 9.

Support base 11 of the pipe support apparatus 10 will preferably be integrally molded from an isolating composite material with the thermal, load, and mechanical properties as may be required for suitable load bearing pipe supports. A suitable isolating composite material will preferably be comprised of fiber reinforced thermoplastic resin material. Suitable fiber reinforcement (not shown) for the fiber thermoplastic resin material for the support base 11 may include discrete fiber segments, including long or short fiber segments or a combination thereof, including metal or metal alloy fibers, glass fibers, synthetic fibers, natural fibers, and woven fiber fabric woven from such fiber materials, including woven fiber fabric impregnated with resin.

Other types of isolating composite material such as fiber reinforced concrete may be utilized also be utilized for the base 11 of pipe support apparatus 10. Suitable fiber reinforced concrete for the support base 11 will be a composite material consisting of mixtures of cement, mortar or concrete and discontinuous, discrete, uniformly dispersed suitable fiber reinforcements. Suitable fiber reinforcement for the fiber reinforced concrete may be discrete fiber segments, including long or short fiber segments or a combination thereof, including metal or metal alloy fibers, glass fibers, synthetic fibers, natural fibers, and woven fiber fabric woven from such fiber materials, including woven fiber fabric impregnated with resin.

Depending upon the load to be supported, the anticipated environmental conditions, or other anticipated design considerations, the base 11 of pipe support apparatus 10 may also be cast, machined, or otherwise constructed of metal or metal alloys such as steel alloys, aluminum alloys, or cast iron. Preferably the apparatus 10 constructed of metal or metal alloys will be constructed of corrosion-resistant metal or metal alloys such as stainless steel or anodized aluminum or provided with a corrosion-resistant coating such as a galvanized coating, a polymer coating, or a bituminous coating as an isolating material.

The pipe support area 24 on the bottom 14 of the base 11 of pipe support apparatus 10 may be provided with a skid-resistant surface 26 as shown in FIG. 3 to increase the coefficient of friction of support area 24. When the pipe support apparatus 10 is in use, as shown in FIGS. 4, 5, and 6, the pipe support area 24 with the skid-resistant surface 26 is positioned upon the upper outer surface 32 of its underlying pipe support structure 30 to reduce slippage between the pipe support area 24 of pipe support apparatus 10 and the support surface 32. Preferably, the skid resistant surface 26 will provide the pipe support area 24 with a coefficient of friction in the range of 0.2μ to 0.8μ.

The skid-resistant surface 26 on support area 24 may be a skid-resistant surface coating such as a ceramic, paint, epoxy, or polymer coating, or combinations thereof having an anti-slip additive such as sand, silica, granulated stone, ceramics, combinations thereof, or other suitable anti-slip additives. It is thought that an anti-slip additive comprised of ceramic material will produce a coefficient of friction in the range ≥0.2μ to ≤0.8μ. The skid-resistant surface 26 of the support area 24 may also be provided by integrally molding the anti-slip additive into the surfaces 15A or 15B of a support area 24 of a desired base 11.

The pipe-on-pipe pipe support apparatus 10 may be used as shown in FIGS. 4, 5 and 6 during the initial construction of a piping system. For use, a support apparatus 10 of a desired predetermined configuration is installed by placing the support area 24 of the support bottom 14 of a support apparatus 10 to rest upon the curved upper surface 32 of a selected pipe support structure 30. Then, after the pipe support apparatus 10 is so installed, the piping P of the piping system is then positioned to rest upon and be supported by the ridges 16 of the support top 12 of the installed pipe support apparatus 10. Any rainwater or other liquids to which the piping P is exposed when so supported will then be collected in the valleys 18 on the support top 12, away from the piping P, thereby minimizing corrosion of the piping P. Guides 22 adjacent the edges 17 of the support area 24 provide strength to the apparatus 10 and serve to retain the pipe support apparatus 10 upon surface 32 of the underling pipe support structure 30.

The upgrade or replacement of an existing pipe support of a piping system with the pipe-on-pipe pipe support apparatus 10 described herein may typically be accomplished by the additional steps of lifting the segment of piping P where a pipe support replacement is desired, removing the existing pipe support from the underlying pipe support structure 30, removing any undesirable debris from the curved upper surface 32 of the underlying pipe support structure 30, if necessary, and then placing a pipe support apparatus 10 of a desired configuration upon the upper surface 32 of the underlying pipe support structure 30, and placing the segment of piping P of the piping system previously lifted upon the ridges 16 on the support top 12 of the replacement pipe support apparatus 10 as shown in FIGS. 4, 5, 6, 9 and 11. This replacement may be accomplished without any welding or attachment of the pipe support apparatus 10 to the underlying pipe support structure 30 or to the piping P.

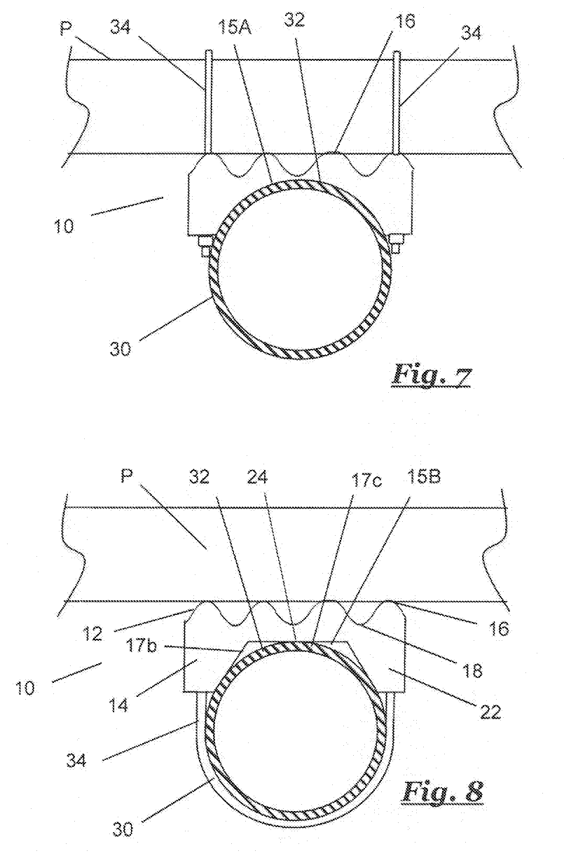

In some situations, it may be necessary to use an attachment mechanism 34 to attach the pipe support apparatus 10 to piping P of a piping system or to the underlying pipe support structure 30. FIG. 7 shows attachment of the pipe support apparatus 10 to the supported piping P of a piping system by U-Bolts as the attachment mechanism 34. FIG. 8 shows the attachment of pipe support apparatus 10 a piping segment that serves as the underlying pipe support structure 30 by U-bolts as the attachment mechanism 34 for support of the piping P. Other suitable attachment mechanisms such as cables, hangers, straps, belts, or clamps may also be utilized as the attachment mechanism 34 to attach the pipe support apparatus 10 to the piping P or to the underlying pipe support structure 30.

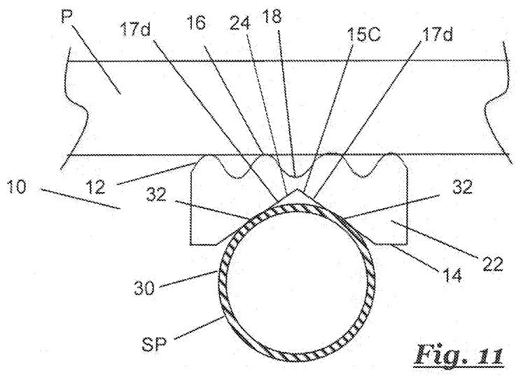

FIG. 10 shows another alternate embodiment of the pipe-on-pipe pipe support apparatus 10 of Applicant's invention. The apparatus 10 shown in FIG. 10 has a support base 11, a corrugated support top 12 with a series of ridges 16 and valleys 18, a support bottom 14 with a pipe support area 24, and a height or thickness 20. However, in the embodiment of FIG. 10, the pipe support area 24 on bottom 14 of apparatus 10 is comprised of intersecting angled support edges 17b that create a beveled V-shaped support surface 15C with adjacent flanges or guides 22. The beveled V-shaped support surface 15C also allows the embodiment of apparatus 10 as depicted FIG. 10 allows the support edges 17 to be positioned upon a curved support surface 32 of an underlying support structure such as a piping segment as shown in FIG. 11. If desired, the pipe support area 24 may also have a skid-resistant surface 26 as previously described and shown in FIG. 3.

It will be evident that various other changes may be made in the form, construction and arrangement of the parts and steps of the apparatus and method described herein without departing from the spirit, scope, and material advantages of the invention. It is also thought that the method and apparatus presented herein will be understood from the foregoing description and that the forms and steps described herein are intended to be merely exemplary embodiments of the invention.

I claim:

1. A pipe support apparatus comprising:
(a) an underlying pipe support structure having a curved support surface;
(b) a pipe support base comprised of an isolating composite material, said pipe support base having a corrugated top with a series of valleys and ridges and a support bottom having a support area conforming to said curved support surface of said underlying pipe support structure;
(c) said support area on said bottom of said base positioned upon said curved support surface of said underlying pipe support structure; and
(d) piping supported on said ridges of said corrugated top of said pipe support base.

2. The pipe support apparatus recited in claim 1 wherein said pipe support base is attached to said piping.

3. The pipe support apparatus recited in claim 1 wherein said pipe support base is attached to said underlying pipe support structure.

4. The pipe support apparatus recited in claim 1 wherein said support area on said bottom of said pipe support base includes a skid-resistant surface.

5. The pipe support apparatus recited in claim 4 wherein said skid-resistant surface on said support area on said bottom of said pipe support base has a coefficient of friction in the range ≥0.2μ and ≤0.8μ.

6. The pipe support apparatus recited in claim 5 wherein said skid-resistant surface includes a coating selected from the group comprising ceramic, paint, epoxy, and polymer coatings.

7. The pipe support apparatus recited in claim 6 wherein said coating on said skid-resistant surface on said support area on said bottom of said pipe support base includes an anti-slip additive selected from the group comprising sand, silica, granulated stone, and ceramic material.

8. The pipe support apparatus recited in claim 7 wherein said support area on said bottom of said pipe support base is comprised of a curved support surface.

9. The pipe support apparatus recited in claim 7 wherein said support area on said bottom of said pipe support base is comprised of intersecting support surfaces creating a V-shaped support area.

10. The pipe support apparatus recited in claim 7 wherein said support area on said bottom of said pipe support base is comprised of intersecting flat and angled support surfaces.

11. The pipe support apparatus recited in claim 7 wherein said isolating composite material of said base includes fiber reinforced thermoplastic resin materials.

12. The pipe support apparatus recited in claim 7 wherein said isolating composite material of said base includes corrosion-resistant metals.

13. A pipe support apparatus comprising:
(a) an underling pipe support structure having a circular support surface;
(b) a pipe support base having a top surface and a bottom surface, wherein said top surface of said pipe support base is a corrugated surface having a series of valleys and ridges and wherein said bottom surface of said pipe support base is a curved support area supported upon said curved support surface of said underlying pipe support structure, said curved support area conforming to said curved support surface of said underlying pipe support structure;
(c) a skid-resistant surface on said curved support area of said bottom surface of said pipe support base, said skid-resistant surface having a coefficient of friction in the range ≥0.2μ and ≤0.8μ;
(d) piping supported upon said ridges of said corrugated surface of said top surface of said pipe support base; and
(e) wherein said pipe support base is comprised of an isolating composite material.

14. The pipe support apparatus recited in claim 13 wherein said skid-resistance surface on said curved support area includes a coating selected from the group comprising ceramic, paint, epoxy, and polymer coatings.

15. The pipe support apparatus recited in claim 14 wherein said coating on said kid-resistant surface on said curved support area includes an anti-slip additive selected from the group comprised of ceramic, sand, silica, and granulated stone.

16. The pipe support apparatus recited in claim 15 wherein said pipe support base is attached to said piping.

17. The pipe support apparatus recited in claim 15 wherein said pipe support base is attached to said underlying pipe support structure.

18. A pipe support apparatus comprising:
(a) an underling pipe support structure having a circular support surface;
(b) a pipe support base having a top surface and a bottom surface, wherein said top surface of said pipe support base is a corrugated surface having a series of valleys and ridges and wherein said bottom surface of said pipe support base has a support area comprised of beveled support surfaces supported upon said circular support surface of said underlying pipe support structure;
(c) a skid-resistant surface on said support area of said bottom surface of said pipe support base, said skid-resistant surface having a coefficient of friction in the range ≥0.2μ and ≤0.8μ;
(d) piping supported on said ridges of said corrugated surface of said top surface of said pipe support base; and
(e) wherein said pipe support base is comprised of an isolating composite material.

19. The pipe support apparatus recited in claim 18 wherein said skid-resistance surface on said support area includes a coating selected from the group comprising ceramic, paint, epoxy, and polymer coatings.

20. The pipe support apparatus recited in claim 19 wherein said coating on said kid-resistant surface on said support area includes an anti-slip additive selected from the group comprised of ceramic, sand, silica, and granulated stone.
